(19) United States
(12) Patent Application Publication
(10) Pub. No.: US 2021/0224727 A1
(43) Pub. Date: Jul. 22, 2021

(54) ASSET MANAGEMENT

(71) Applicant: Cameron International Corporation, Houston, TX (US)

(72) Inventors: Vikas Rakhunde, Cypress, TX (US); Zachary Hrabak, Houston, TX (US)

(21) Appl. No.: 16/747,667

(22) Filed: Jan. 21, 2020

(51) Int. Cl. G06Q 10/08; G06Q 10/06; G06K 7/00; G08B 13/24; G06K 7/10

(52) U.S. Cl. CPC G06Q 10/087; G06Q 10/0631; G08B 13/2462; G08B 13/2417; G06K 7/10079; G06K 7/0008

(57) ABSTRACT

A lifecycle history tracking system for assets such as oilfield components and equipment supply uses blockchain technology. Items such as components and assemblies are tracked at various stages that includes recorded environmental data and other information such as testing, certification, transportation conditions, repair, and use conditions. The tracking uses RFID scanners at various stages and each component and assembly has a unique RFID tag. The relevant information is uploaded via nodes maintained by the various parties and added to a common blockchain and the new data is verified by other nodes. Condition based maintenance and improved inventory tracking is facilitated.

### TECHNICAL FIELD

The present disclosure relates to systems and methods for managing the lifecycle of moveable assets. More specifically, the present disclosure relates to systems and methods for managing moveable assets such as components used in the oilfield industry using the blockchain and/or distributed ledger, IOT (Internet of Things) and RFID technologies.

### BACKGROUND

This section is intended to introduce the reader to various aspects of art that may be related to various aspects of the present disclosure, which are described or claimed below. This discussion is believed to be helpful in providing the reader with background information to facilitate a better understanding of the various aspects of the present disclosure. Accordingly, it should be understood that these statements are to be read in this light, and not as admissions of prior art.

In the oilfield industry, lifecycle tracking of assets, such as components used in oilfield service equipment, is often accomplished manually and may be only intermittently completed. For example, enterprise resource planning (ERP) software or other business management software may be used. Manually managing the asset data is expensive and may not be effective for tracking the entire history of the component. In some cases, there may be breaks in data. For example, when a customer takes ownership of the asset, the service company may lose visibility over some aspects of the asset, such as how it is moved, maintained, etc. This lack of data makes providing a full lifecycle asset management service more difficult or impossible and may hinder the service company's ability to maintain performance partnerships. For many types of oilfield equipment components, for example components used in pressure control equipment, tracking can be especially beneficial since it can save costs in testing, repairing or replacing components by increasing accuracy in component targeting.

### SUMMARY

This summary is provided to introduce a selection of concepts that are further described below in the detailed description. This summary is not intended to identify key or essential features of the claimed subject matter, nor is it intended to be used as an aid in determining or limiting the scope of the claimed subject matter as set forth in the claims.

According to some embodiments, a system for tracking moveable assets used in an oilfield related activity is described. The system includes: a plurality of nodes, each node configured to generate, store and validate blocks of data, the validated blocks of data stored at the plurality of nodes forming a distributed ledger; a plurality of facilities, each facility including at least one automatic identification and data capture (AIDC) reader and an environmental sensor, the AIDC reader and the sensor each being in communication with at least one node; a plurality of moveable asset items each including an AIDC tag containing encoded data and configured to have the data read by the AIDC reader. When one of the asset items enters one of the plurality of facilities the ADIC reader at the facility reads the encoded data of the ADIC tag of the asset item. At node is configured to receive information indicating the entry of the asset item into the facility and information indicating measurements from the environmental sensor at the facility, generate therefrom a block of data and append the block of data to the distributed ledger.

According to some embodiments, the distributed ledger is a blockchain ledger, the AIDC reader is an RFID reader and the AIDC tag is an RFID tag. According some embodiments, the encoded data contained in the AIDC tag are encrypted.

According to some embodiments, the moveable asset items are oilfield equipment and components used in oilfield equipment. The plurality of facilities can include at least one component supplier facility, at least one equipment assembler facility and at least one user field site.

According to some embodiments, the oilfield equipment is pressure control equipment configured to be used in oilfield drilling operations, and the user field site is a drilling rig site. The plurality of facilities can further include at least one component repair facility and information indicating results of repair of a component is received by a node which is configured to generate therefrom a block of data and append the block of data to the distributed ledger. The plurality of facilities can also include at least one component testing facility and information indicating results of testing of a component is received a node which is configured to generate therefrom a block of data and append the block of data to the distributed ledger. The environmental sensors can be configured to measure one or more environmental conditions such as: temperature, moisture, humidity, dust, and gas.

According to some embodiments, a method for tracking moveable asset items used in an oilfield related activity is described. The method includes: at a first facility, reading with an automatic identification and data capture (AIDC) reader the presence at the facility or entry into the facility of a first moveable asset item, the moveable asset item including an AIDC tag containing encoded data and configured to have the data read by the AIDC reader; and at the first facility reading with an environmental sensor, at least one environmental condition at the first facility. The method further includes, at a first node, receiving information indicating the presence or entry of the asset item into the first facility and information representing environmental conditions measured with the sensor; generating from the received information a block of data; and appending the block of data to a plurality to a distributed ledger. The method further includes, at a plurality of other nodes, validating the block of data appended by the first node.

According to some embodiments, the method further includes performing one or more of the following based at least in part on the measured environmental condition information associated with a component stored in the blockchain ledger: monitoring the component, testing the component, repairing the component and replacing the component. According to some embodiments, the method further includes managing inventory based at least in part on the blockchain ledger.

### BRIEF DESCRIPTION OF THE DRAWINGS

The subject disclosure is further described in the following detailed description, and the accompanying drawings and schematics of non-limiting embodiments of the subject disclosure. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a simple block diagram illustrating an oilfield component and equipment supply chain arrangement in which improved lifecycle asset management use blockchain technology can be implemented, according to some embodiments;

FIG. 2A is a diagram illustrating further details of improved lifecycle management for oilfield components and equipment using blockchain technology, according to some embodiments; and

FIG. 2B is a diagram illustrating some of the symbology used in FIG. 2A.

### DETAILED DESCRIPTION

One or more specific embodiments of the present disclosure will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Like reference numerals are used herein to represent identical or similar parts or elements throughout several diagrams and views of the drawings.

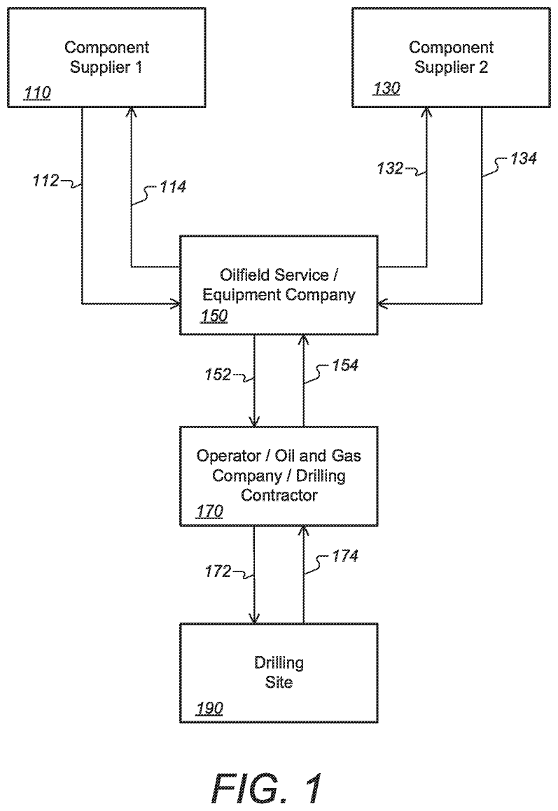

FIG. 1 is a simple block diagram illustrating an oilfield component and equipment supply chain arrangement in which improved lifecycle asset management use blockchain technology can be implemented, according to some embodiments. In this example, two component suppliers 110 and 130 supply components that are used in oilfield service equipment to company 150, as indicated by arrows 112 and 132. The company might also ship one or more of the components back to the suppliers 110 and 130, for example for purposes of testing, service, repair, refurbishment, recertification, etc. This return is indicated by arrows 114 and 134. In some cases, company 150 is an oilfield service/equipment company. The service/equipment company 150 assembles the equipment and provides the equipment, indicated by arrow 152, to the “customer” 170 which can be, for example, an operator, oil and gas company, or drilling contractor. In some cases, the customer 170 may return the equipment to the company 150 such as for purposes of testing, service, repair, refurbishment, recertification, etc. This return is indicated by arrow 154. The customer 170 deploys the equipment at a field site 190, as indicated by arrow 172. In some cases, the field site 190 is a drilling cite. After deployment, the customer my retrieve the equipment from the site, as indicated by arrow 174. According some embodiments, the equipment being supplied by company 150 is pressure control equipment, such as blow out preventers (BOPs), and the components being supplied by suppliers 110 and 130 are components for the pressure control equipment such as valves or elastomers.

According to some embodiments, vendors/suppliers 110 and 130, company 150 and customer 170 are able to “trade” data related to components and other assets (such as equipment) with each other while minimizing the amount of trust relied upon by any of the parties. Many of the techniques described herein are based on consensus formed between “nodes” based on data provided by a system of interrelated and interconnected devices such as machines, sensors, objects, etc., forming an Internet of Things (IoT). The IoT devices are installed at each facility of each party. In the case of FIG. 1, this includes the relevant facilities of suppliers 110 and 130 and company 150, as well as for customer 170, including drilling (or other field) site 190. As is known with blockchain technology, all of the nodes are properly incentivized to “kick out” or reject “bad actors.” The greatly reduced reliance on trust between parties due to blockchain is sometimes referred to as “trustless.” According to some embodiments, techniques for lifecycle management of assets is described. According to some embodiments, the oilfield equipment assets are moveable assets such as equipment used in the oilfield industry. According to some embodiments, the managed assets are equipment used in the oilfield drilling process such as pressure control devices including blow out preventers (BOPs), and/or components used in such equipment.

Benefits provided by one or more of the described embodiments can include one or more of the following: (1) inventory tracking by customers, vendor/suppliers, and other supply chain member locations which can facilitate inventory reduction; (2) tracking customer usage history of assets to obtain or improve performance histories; (3) avoiding delay and costs associated with unnecessary multiple quality checks at different locations by sealing the package at the first factory acceptance test (FAT) site and verifying seals using scanners without manual interfaces; (4) providing a “heads up” or early warning to vendors to product/manufacture additional components when inventory falls below a predetermined threshold level; (5) allowing vendors to compete with each other since they can learn the inventory levels via decentralized portal(s), thereby potentially decreasing costs; (6) provide information/notification when components in a warehouse are not following first-in-first-out process for inventory, thereby reducing likelihood of components losing life on the shelf; (7) facilitating resolution of warranty disputes by using the lifetime and usage history of the components; (8) facilitating tracking of the components; and (9) facilitating tracking of the location of loss.

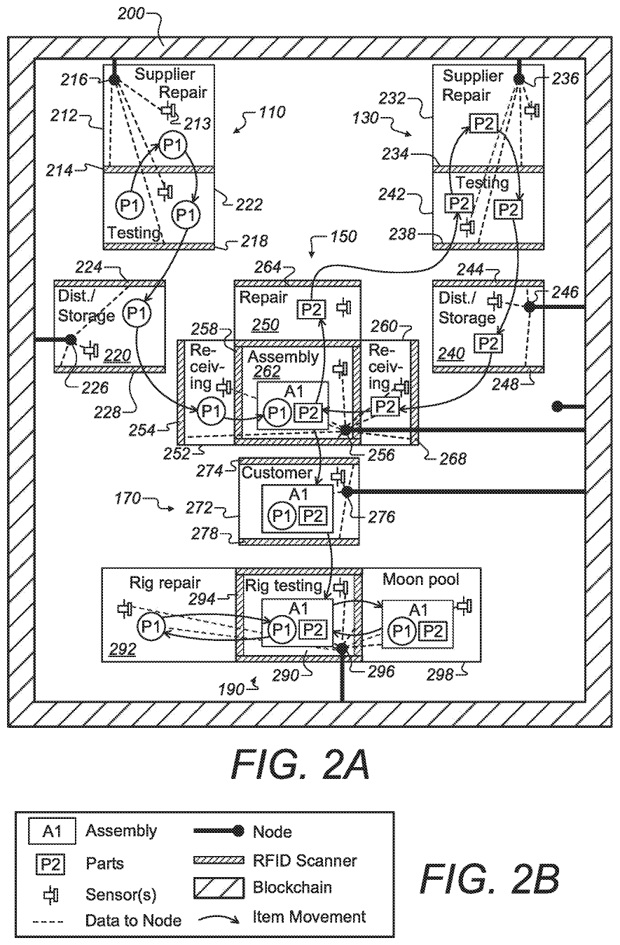

FIG. 2A is a diagram illustrating further details of improved lifecycle management for oilfield components and equipment using blockchain technology, according to some embodiments. FIG. 2B is a diagram illustrating some of the symbology used in FIG. 2A. According to some embodiments, the assets are tracked via RFID tags scanned through RFID scanners every time an asset moves through various stages as shown in FIG. 2. The assets from suppliers 110 and 130, in this example P1 and P2, respectively, move through different locations shown in FIG. 2 while their “status/location” is broadcasted on the blockchain 200. For example, in supplier 110's component repair room 212. Also, in the repair room 212 are one or more sensors 213 and node 216. The sensors 213 include one or more of the following: temperature sensors, moisture/humidity sensors, dust sensors, and gas detectors. The node 216 detects the presence of component P1, readings from the sensors 213, and RFID scanners 214 and 218 as indicated by the dashed lines. The component P1 (as well as the other component P2 as well as the assembly A1 include RFID tag(s) so that the RFID scanners can detect the location of each asset. By detecting the time when various assets move across RFID scanners, the duration that each asset spends in each location can be determined. From the sensors the duration that each asset has been exposed to each measured environmental condition can also be determined and appended to the blockchain via the relevant node. In this way the lifecycle history about each of the assets can be determined and made available via the blockchain.

According to some embodiments, assembly A1 is a blowout preventer (BOP) being assembled and supplied by company 150 to customer 170. Customer 170 can be, for example, an operator, oil and gas company and/or a drilling contractor. The customer 170 installs the BOP assembly A1 at drilling rig site 190. In this example, two components P1 and P2 are shown being supplied by supplier 110 and supplier 130. The component P1 in an example is an elastomer component and the component P2 is a valve. Each of the components, P1 and P2, include RFID tags installed by their respective suppliers 110 and 130. According to some embodiments, the RFID tags on P1 and P2 can be randomly generated using each supplier's private key. The RFID tags on components P1 and P2 are scanned and populated on the blockchain 200 using nodes 216 and 236. Using the RFID tags on the components and the scanners located at each entry and exit point of each location, the components are tracked trough each stage throughout each component's lifetime. Thus, the company 150 can track each component from the supplier (vendor) source to operation (e.g. on a drilling rig), and can facilitate condition based monitoring of various components.

Shown for suppliers 110 and 130 are repair locations 212 and 232, respectively. Every time a repair is been made at vendor site the tracked component is scanned through RFID scanners installed at each stage(room). For example, scanners 214 and 234 are used to scan components P1 and P2 entering and leaving their respective repair locations 212 and 232. Note that although in this example, component P1 and P2 are shown being repaired by their respective vendors 110 and 130, according to some embodiments, the repair of a component may be made at repair facility that is run by the original manufacturer. For example, elastomer P1 might be repaired by vendor 130 in repair location 232 and this would be tracked via RFID scanner 234 and associated with conditions from the sensors located within location 232 (e.g. temperature sensors, moisture/humidity sensors, dust sensors, and gas detectors). Also shown in FIG. 2A are testing facilities 222 and 242 for suppliers 110 and 130, respectively. The testing facilities 222 and 242 include RFID scanners 218 and 238, respectively, that track each component entering or leaving the testing facility, to and from the distribution and storage locations 220 and 224, respectively. According to some embodiments, all test results, certifications and other data relating to testing of components carried out at the testing facilities are associated with the component and populated to the blockchain 200 using the nodes 216 and 236. RFID scanners 224 and 244 scan the entry of components P1 and P2 from the testing facilities 222 and 242 into distribution and/or storage facilities 220 and 240, respectively. The facilities 220 and 240 include sensors so that the environmental conditions for each component can be tracked. Note that facilities 220 and 240 can be stationary locations such as distribution and/or storage warehouses. According to some embodiments, facilities 220 and 240 include mobile facilities used for transportation such as trucks, shipping crates, shipping containers, train cars, etc. For example, the facilities 220 and 240 can include shipping boxes, crates or containers used to transport the components P1 and P2 to between the locations of customer 150 and suppliers 110 and 130. Additionally, since the facilities 220 and 240 include sensors (e.g. temperature sensors, moisture/humidity sensors, dust sensor, and gas detectors), the environmental conditions, over time, can be tracked and uploaded to blockchain 200 from notes 226 and 246. According to some embodiments, the history at supplier sites and facilities is stored on in a decentralized manner (i.e. blockchain 200) and hashed with encryption key owned by supplier. According to some embodiments, facilities 220 and/or 240 can be transportation facilities owned and/or operated by third parties which may have their own private key generated RFID tags that are attached to the components being transported. The tracking, location and sensor data information is populated to the blockchain 200 e.g. through nodes 226 and 246, which in the case of transport can be mobile nodes.

Whenever the company 150 receives an item, its facilities it will be automatically scanned through scanner (like EZ tag) installed at warehouse (e.g. RFID scanner 254 for receiving facility 252 and RFID canner 268 for receiving facility 260. The received item information is populated on the blockchain 200 (e.g. via node 256) and verified by the blockchain 200. The data related to the components, including its history, are then transferred to company 150 using its private key and company 150 will have access to all the data related to the component with the transfer of ownership.

From receiving facilities 252 and 260 the components can be transferred to assembly area through the scanner 258 installed at assembly area 262. This data is also populated on the blockchain 200. After the parts P1 and P2 have been assembled on the assembly A1 (e.g. the BOP or BOP Stack), each part (e.g. P1 and P2) still has its own RFID tag. Whenever assembly A1 is scanned through an RFID scanner the history and other data are again populated on the blockchain 200 with all the components that are included in the assembly A1. Since each of the components assembled on each assembly has its own unique RFID, each assembly including all of its components can have their entire lifecycle histories tracked.

In case the assembly or a component is repaired in the company's repair facility 250, the exit from assembly area 262 and entry into repair facility 250 is tracked by scanner 258. In FIG. 2A a component P2 is shown in the repair facility 250. In the case when a component needs further repair or testing, it can be transported back to the supplier as is shown with component P2 being sent back to the testing facility 242 and repair facility 232 of supplier 130. Note that the transportation facility is not shown but could be a monitored and tracked transportation facility such facilities 220 and 240 described supra. At the supplier, the component may undergo further testing and repair and the relevant information is populated on the blockchain 200.

Whenever an assembly (such as BOP or BOP Stack assembly A1) is shipped to a customer (such as customer 170) it will have an exit scan (e.g. from scanner 258) and an arrival scan (e.g. from scanner 274) at customer side. The exit and entry data are populated on the blockchain 200. According to some embodiments, the data related to the components (P1 and P2) and the assembly (A1) with histories are then transferred to the private key if customer 170 with the transfer of ownership. According to some embodiments, company 150 will continue to have access to all the data related to the assembly and components after the transfer of ownership. Note that a transportation facility between company 150 and customer 170 is not shown but could be monitored and tracked transportation facility such facilities 220 and 240 described supra.

According to some embodiments, every party involved in the activities shown in FIG. 2A (e.g. supply, assembly, use, transportation, testing, and repair) operates a node, and all or some authorized nodes can have the same blockchain 200 ownership information stored therein. At every stage, the RFID scanner(s) scans the tracked items passing by and uploads the history data, including the environmental conditions, to the blockchain 200 or centralized encrypted secured nodes. Each new upload is copied, and ownership is verified by all of the other nodes. According to some embodiments, all of the parties can have access to same data related to the components and assemblies stored on the decentralized blockchain 200 based on permission level. Customers (such as customer 170) each have a unique RFID for each field site (e.g. drilling rig site 190) that is generated through their private key. As soon as the assembly A1 arrives at the field site 190, the RFID associated tag with assembly A1 (e.g. the BOP or stack) is scanned by the Rig RFID scanner 294 and the information, along with the environmental conditions (temperature, moisture, dust, gas, etc) is appended to the blockchain 200. In the example of FIG. 2A, the assembly A1 is initially received by rig testing facility 290. In case the assembly A1 or one of its components (e.g. P1 or P2) are repaired at the customer's repair facility 292, then this can be tracked via the RFID scanner 294 and the sensors within facility 292. In the case the drilling rig site 190 is an off-shore drill ship, moving the assembly A1 to the moon pool 298 can also be tracked by RFID scanner 294.

According to some embodiments, a “bad actor” who falsifies the data by manipulating transaction of scanner will be penalized by not receiving the rewards through data mining permission. “Bad actors” can be also prevented or rejected using known blockchain techniques including, but not limited to: proof of work (POW), proof of stake (POS), Proof of Authority (POA) and/or delegated proof of stake (DPOS). Similarly, incentive to reward “good actors” will be generated by a transaction fee charged when the components passes through the scanner and will be paid by private key holder. According to some embodiments, the data generated through the scanner could be traded to other parties for their benefit or incentives.

According to some embodiments, the described lifecycle tracking system can be used to facilitate condition-based maintenance for various components. Each usage of the component can be tracked including relevant measured environmental and other use data. Additionally, each repair, modification, testing, storage, and transportation event can also be tracked and include measured environmental data as well.

According to some embodiments, the described tracking system can also be used to facilitate inventory management. For example, the company 150 can easily determine how much inventory is being held by each supplier, customer and also within each of its own facilities.

According to some embodiments, some or all of the tracked information is encrypted such that only a private encryption key hold with the correct permissions can access the detailed information.

According to some embodiments, access to some or all of the data contained in blockchain 200 could be allowed according to pre-negotiated contract terms between the suppliers 110 and 130, company 150 and/or customer 170. The term “smart contract” as used herein refers to a predefined contract that can form part of the blockchain. In a smart contact, the contract terms can be written, coded, distributed and validated on the blockchain. Terms of the contact can be triggers and/or performed automatically, or can be manually triggered and/or performed based on the transactions made according to or verified by the blockchain. Examples include term based on time or based on readings from IOT devices. Examples of smart contracts or contract terms include the following cases. For the transfer of ownership of data, a smart contract can be written in such a way that some predefined portion, or all the data, is automatically transferred when the component is delivered to receiving party. In the case of dispute resolution, a smart contract can be written such that all or part of the relevant data is automatically shared with one or more of the parties and/or with a third party in order to facilitate resolution of the dispute. In the case of a purchase order, a smart contract can be written to remit funds according to an invoice as soon as the part or component is detected by RFID reader at the destination. The smart contract can include terms that it penalizes the manufacturer for late delivery. Payment can be deducted from the recipient's account automatically upon successful delivery. For conditions-based maintenance, the IOT and location data related to the parts can be used to evaluate condition(s) associated with the part/component for possible service or maintenance. The smart contract can be written to monetize the data to the beneficiary. Furthermore, the same data can be used for improvement of the component as vendor could evaluate the condition and improve the part performance.

While much of the description above has been in the context of the tracked assembly were pressure control devices such as a BOP or BOP stack, according to some embodiments, the described tracking system can be used in any other oilfield equipment setting and for any other type of components and oilfield equipment that can benefit from detailed tracking information. For example, the assembly A1 can be a wireline tool, and the component P1 and P2 can components for the wireline tool. Other examples include equipment used for completion, stimulation, seisemic exploration, etc.

While the disclosure may be susceptible to various modifications and alternative forms, specific embodiments have been shown by way of example in the drawings and have been described in detail herein. However, it should be understood that the disclosure is not intended to be limited to the particular forms disclosed. Rather, the disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for” or “step for” performing a function, it is intended that such elements are to be interpreted under 35 U.S.C. 112(f). However, for any claims containing elements designated in any other manner, it is intended that such elements are not to be interpreted under 35 U.S.C. 112(f). While the subject disclosure is described through the above embodiments, it will be understood by those of ordinary skill in the art, that modification to and variation of the illustrated embodiments may be made without departing from the concepts herein disclosed.

What is claimed is:

1. A system for tracking moveable assets used in an oilfield related activity, the system comprising:
a plurality of nodes, each node configured to generate, store and validate blocks of data, the validated blocks of data stored at the plurality of nodes forming a distributed ledger;
a plurality of facilities, each facility including at least one automatic identification and data capture (AIDC) reader and at least one environmental sensor, the AIDC reader and the at least one sensor each being in communication with at least one node;
a plurality of moveable asset items each including an AIDC tag containing encoded data and configured to have said data read by an AIDC reader, wherein when one of said asset items enters one of the plurality of facilities the at least one ADIC reader at the facility reads the encoded data of the ADIC tag of the asset item, and at least one node being configured to receive information indicating the entry of the asset item into the facility and information indicating measurements from the at least one environmental sensor at the facility, generate therefrom a block of data and append the block of data to the distributed ledger.

2. The system according to claim 1 wherein said distributed ledger is a blockchain ledger.

3. The system according to claim 1 wherein said at least one AIDC reader is an RFID reader and said AIDC tag is an RFID tag.

4. The system according to claim 1 wherein said encoded data contained in said AIDC tag is encrypted.

5. The system according to claim 1 wherein said moveable asset items are oilfield equipment and components used in oilfield equipment.

6. The system according to claim 5 wherein said plurality of facilities include at least one component supplier facility, at least one equipment assembler facility and at least one user field site.

7. The system according to claim 6 wherein said oilfield equipment is pressure control equipment configured to be used in oilfield drilling operations, and said user field site is a drilling rig site.

8. The system according to claim 6 wherein said plurality of facilities further includes at least one component repair facility and information indicating results of repair of a component is received by at least one node which is configured to generate therefrom a block of data and append the block of data to the distributed ledger.

9. The system according to claim 6 wherein said plurality of facilities further includes at least one component testing facility and information indicating results of testing of a component is received by at least one node which is configured to generate therefrom a block of data and append the block of data to the distributed ledger.

10. The system according to claim 1 wherein plurality of facilities further includes at least one transportation facility of a type selected from a group consisting of: truck, ship, train car, box, crate, container, and shipping container.

11. The system according to claim 6 wherein said at least one equipment assembler facility includes a computer system configured to performing one or more of the following based at least in part on the measured environmental condition information associated with components stored in the blockchain ledger: monitor the component, test the component, repair the component and replace the component.

12. The system according to claim 6 wherein said at least one equipment assembler facility includes a computer system configured to manage inventory of said components used in oilfield equipment based at least in part on the blockchain ledger.

13. The system according to claim 6 wherein said oilfield equipment is wireline equipment configured to be used to perform downhole wireline measurements, and said user field site is a wellsite.

14. The system according to claim 1 wherein said at least one environmental sensor is configured to measure one or more environmental conditions of a type selected from a group consisting of: temperature, moisture, humidity, dust, and gas.

15. A method for tracking moveable asset items used in an oilfield related activity, the method comprising:
at a first facility, reading with an automatic identification and data capture (AIDC) reader the presence at said facility or entry into said facility of a first moveable asset item, the moveable asset item including an AIDC tag containing encoded data and configured to have said data read by the AIDC reader;
at the first facility reading with an environmental sensor, at least one environmental condition at said first facility;
at a first node:
receiving information indicating the presence or entry of the asset item into the first facility and information representing environmental conditions measured with the sensor;
generating from the received information a block of data; and
appending said block of data to a plurality to a distributed ledger; and
at a plurality of other nodes, validating said block of data appended by said first node.

16. The method according to claim 15 wherein said distributed ledger is a blockchain ledger, said AIDC reader is an RFID reader, said AIDC tag is an RFID tag, and said encoded data contained in said RFID tag is encrypted.

17. The method according to claim 15 wherein said moveable asset items are oilfield equipment and components used in oilfield equipment, said first facility is of a type selected from a group consisting of: supplier facility, equipment assembler facility, and user field site.

18. The system according to claim 17 wherein said first facility is a component repair facility, and the method further comprising at the first node:
receiving information indicating results of repairing of the component;
generating from the information indicating results of repairing a second block of data;
and appending said second block of data to the distributed ledger.

19. The method according to claim 17 wherein said first facility is a component testing facility, and the method further comprising at the first node:
receiving information indicating results of testing of the component;
generating from the information indicating results of testing a second block of data;
and appending said second block of data to the distributed ledger.

20. The method according to claim 17 further comprising performing one or more of the following based at least in part on the measured environmental condition information associated with a component stored in the blockchain ledger:
monitoring the component, testing the component, repairing the component and replacing the component.

21. The method according to claim 17 further comprising managing inventory based at least in part on the blockchain ledger.
